(19) United States
(12) Patent Application Publication
(10) Pub. No.: US 2002/0103946 A1
(43) Pub. Date: Aug. 1, 2002

(54) Data transmission devices and data communication systems capable of operating with a plurality of protocols

(76) Inventor: Martin Gaiser, Alpirsbach (DE)

Correspondence Address: NATH & ASSOCIATES, 1030 15th STREET, 6TH FLOOR, WASHINGTON, DC, 20005, US

(21) Appl. No.: 10/058,315

(22) Filed: Jan. 30, 2002

Related U.S. Application Data
(60) Provisional application No. 60/273,335, filed on Mar. 6, 2001.

(30) Foreign Application Priority Data
Jan. 31, 2001 (DE) 101 04 143.8

(51) Int. Cl. G06F 13/42

(52) U.S. Cl. 710/11; 710/105

(57) ABSTRACT

The invention relates to master or slave devices for data communication on a bus, to which bus various devices are attached. The master device (2) is able to address a slave device (1) attached to the bus with messages using a plurality of different protocols and to ascertain whether the slave device responds correctly to the protocol. Thus it can work together with slave devices which command only a single protocol, and the protocols employed by the different slave devices can be different ones. At the same, a slave device capable of using a plurality of protocols is proposed, which is able to evaluate messages received over the bus (3) according to a plurality of different protocols and, when the evaluation according to one of the employed protocols yields an executable instruction, the slave device is able to execute that instruction.

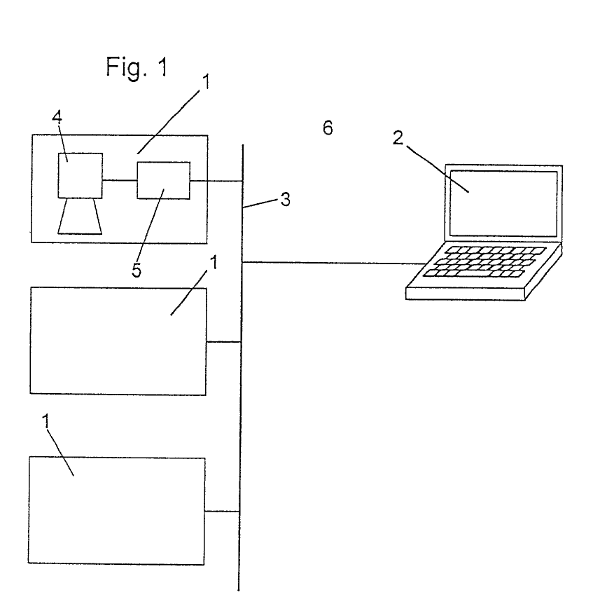

The present invention relates to devices for data communication on a bus, as well as to data communication systems that are able to exchange messages according to a plurality of different protocols.

In the field of process automation a number of protocols for data communication are common, the best-known of which are the so-called profibus and the fieldbus of the Fieldbus Foundation (FF). These two protocols are not compatible, with the result that communication devices functioning according to different protocols cannot be used on a common bus and cannot communicate with each other. This forces manufacturers of data communication devices either to decide on one of the two wide-spread bus protocols in their product spectrum—with the result that users of the other protocol cannot be served—or to operate expensive dual configurations in order to be provide potential customers with devices for the protocol they prefer. A result of the latter solution is that devices must be manufactured in a great variety of types. This variety of types makes the storage of finished devices expensive; storage is necessary, however, to meet short-term user demand.

The variety of types is disturbing to the user of the devices himself, however, because it creates the problem of devices incompatible with the bus system used by the customer being purchased out of insufficient knowledge.

Thus, both the manufacturer and the user have an interest in reducing the variety of types for these devices.

The goal of the invention is to indicate a way of reducing this variety of types.

For data communication devices which operate on a bus a distinction is made between master and slave devices; a master device is viewed as a device that has the authorization or ability to transmit a message on the bus without coordination with other devices, while devices referred to as slave devices are those which do not have this authorization or capability and are given permission to transmit such messages by a master device. It should be noted that a given device can operate alternately as a master and a slave device.

In keeping with this distinction in data communication devices, the goal of the invention is solved both by a master device according to claim 1 and by a slave device according to claim 3.

The master device is characterized by its ability to address a slave device attached to the bus with messages according to a plurality of protocols and to decide whether the slave device that has been addressed provides an answer that can be evaluated according to the employed protocol, and if that is the case, to evaluate the received answered on the basis of this protocol. I.e., if the master device does not obtain a usable answer from a slave device addressed according to an initial protocol, it will address the slave device with a message according to a second protocol and will continue to check through the different protocols available to it until a usable answer is received from the slave device or until it has run through all available protocols unsuccessfully.

Since checking through different protocols for each individual message is time-consuming the master device will preferably have the ability to assign to the slave device the protocol that has led to a usable response from the slave device, for the sake of further communication with the slave device. That is, in further communication with the slave device the master device will from the outset employ that protocol that has led to the usable response, without first checking through other protocols.

The slave device according to the invention is characterized by its ability to evaluate according to a plurality of different protocols a message received over the bus and by its ability to decide whether the evaluation according to the employed protocol yields an instruction that can be executed by the slave device and, if so, to execute that instruction.

This kind of slave device is compatible with every master device that employs at least one of the protocols available to the slave device.

Also in the case of a slave device the instruction contained in the message can be more rapidly executed if the slave device is able to preselect for further communication the protocol according to which the received message was evaluated. This reduces the probability of unsuccessful attempts at evaluation.

Particularly preferred is a further elaboration of the slave device which is able to preselect for the further communication with the transmitter the protocol according to which the received message was evaluated. For each additional device which is attached to the bus and from which it has already received a message, this kind of slave device knows the protocol employed by that additional device and can identify the employed protocol on the basis of the transmitter address of a message, without having to try to interpret the message and identify the instruction contained in the message. Thus, this kind of device can cooperate rapidly and efficiently with various other bus devices that may transmit messages according to different protocols.

The slave devices will ideally include a sensor, particularly one which can measure process magnitudes such as the filling level and which can be configured and/or interrogated with the aid of messages received from the bus.

The communication protocols which the device commands will ideally include at least the fieldbus protocol and the profibus protocol.

The subject matter of the invention is also a data communication system, with a bus to which is attached at least one master or slave device of the type described above.

Other features and advantages of the invention will emerge from the following description of exemplary embodiments, which is made with reference to the attached figure.

The figure depicts in purely schematic fashion a data communication system with a master device 2 and a plurality of slave devices 1, which are attached to a shared bus 3.

First the case will be examined of a master device 2 designed according to invention. This master device can be, e.g., a control computer for an industrial production process. It is able to communicate selectively according to the fieldbus or the profibus protocol. Among the slave devices 1 are devices which understand the fieldbus protocol, as well as those able to process the profibus protocol. The slave devices can be, e.g., sensors for measuring process magnitudes, or executing elements for changing such magnitudes. Upon initial startup of the communication system the master device 2 has no information at its disposal on the protocols that are employed by the slave devices 1. In order to determine the bus addresses for the slave devices present and the protocols used by the slave devices the master device 2 transmits a message to all available addresses in turn, first in the profibus format, then in the fieldbus format (or vice versa) a message whose only purpose is to occasion the slave device 1 attached to the given address to give a response and thus to permit the master device 2 to establish the presence of said slave device 1. In principle, therefore, the message may contain any instruction to the slave device, as long as it provokes a response from the slave device.

If the master device 2 receives an answer to a message transmitted in the profibus format, it concludes that a slave device 1 compatible with profibus is attached to the given address and it records the fact. If not, it transmits a message in the fieldbus format to the same address. If an answer arrives, it records the fact that the given address is occupied by a fieldbus-compatible slave device. If there is no answer the master device concludes that the address is not occupied.

After all addresses are investigated in this manner the master device knows the protocols with which the attached slave devices 1 can be addressed and from then on transmits messages to each of them using the protocol recorded in connection with the specific slave device 1. The messages can be instructions for configuring the slave device 1, or, in the case of a sensor, e.g., data on the measuring resolution, or instructions for transmitting a measured value to the master device 2.

For those addresses at which a slave device was not found the above-described investigation can be repeated periodically in order to identify slave devices added in the course of operating the data communication system and to incorporate them into communication.

To accelerate the process a user can submit to the master device for investigation an address range that is smaller than the one physically possible.

For a fieldbus system it is customary to set up the attached device by means of a configuration tool. The message used in testing the slave devices for fieldbus compatibility may consist in the application of this kind of configuration tool, or in parts of the same, while a return message from the configured device concerning successful configuration may be viewed as a response to the master device evaluatable according to the fieldbus protocol.

The second case to be examined is that of a slave device 1 designed according to the invention, but with a master device 2 that commands only a single protocol.

When the master device 1 involved is a profibus device the master device 1, in identifying a slave device, can transmit a so-called slave diagnosis command to the given address. The slave device will apply the communication protocols it commands in series in order to evaluate the message, and the evaluation will succeed when a profibus protocol is applied. The slave device then produces a response according to the profibus protocol in order to announce to the master device 2 that it is not yet configured. Then messages received on the bus 3 or from the master device 2 which contain configuration commands are evaluated and executed in advance by the slave device 1 under application of the profibus protocol.

If the master device 2 is a fieldbus device the slave device 1 can identify this from the format of the messages that it receives when the fieldbus configuration tool is used. After the terminal device has identified that the master is a fieldbus device, additional message received from it will be directly evaluated according to the fieldbus protocol.

Also conceivable is an application in which a slave device receives messages which contain an executive order not only from the master device 2 but also from other slave devices 1. Here the slave devices, if they have a master according to the invention, will transmit messages entirely according to different protocols. In this kind of system a slave device 1 on the bus 3 can receive messages over time that belong to different protocols.

Different possibilities are available to process these messages. In an initial, simple possibility the slave device capable of handing different protocols always attempts to perform processing according to that protocol which was successful with the immediately preceding message. This means that the slave device—when it last received a profibus message from the master device 2 and then receives a fieldbus message from another slave device - first attempts to process the message according to the profibus protocol, and only when this fails does it switch to processing with the fieldbus protocol. A system like this is particularly easy to realize, but has a disadvantage in that processing of the messages is delayed when messages according to different protocols are frequently exchanged on the bus 3, and the delay is the more conspicuous with an increasing number of different protocols commanded by the devices and run through by them. This kind of delay can be avoided for a received message if the slave device first attempts only to identify the sender and is able, on the basis of a previously established record of the protocol employed by the given sender, to immediately select and, in processing the message, to apply the protocol which the sender has actually used.

1. A master device (2) for data communication on a bus (3), to which bus various devices (1, 2) can be attached, wherein the master device (2) is able to address with messages a slave device (1) attached to the bus (3) according to a plurality of different protocols and is able to decide whether the addressed slave device (1) provides an answer that can be evaluated according to the employed protocol, and, if so, is able to evaluate the received response on the basis of that protocol.

2. A master device according to claim 1, wherein said device is able to permanently assign to the slave device (1) the protocol that resulted in a usable response from the slave device (1), for the sake of further communication with the slave device (1).

3. A slave device (1) for data communication on a bus (3), to which bus various devices (1, 2) can be attached, wherein the slave device is able to evaluate a message received over the bus (3) according to a plurality of different protocols and is able to decide whether the evaluation according to the employed protocol yields an instruction that can be executed and, if so, is able to execute the instruction.

4. A slave device according to claim 3, wherein said device is able to preselect the protocol with which it was possible to evaluate the received message, for the sake of further communication over the bus (3).

5. A slave device according to claim 3 or 4, wherein said device is able to preselect the protocol with which is was possible to evaluate the received message, for the sake of further communication with the sender of the message.

6. A slave device according to one of claims 3 to 5 or for use with a master device according to claim 1 or 2, wherein said device includes a sensor, particularly a filling level sensor, which can be configured and/or can be interrogated by means of messages received over the bus (3).

7. A device according to one of the preceding claims, wherein the plurality of different protocols includes at least the fieldbus protocol and the profibus protocol.

8. A data communication system with a bus (3) suitable for the transmission of messages according to a plurality of different protocols, to which system at least one device (1, 2) according to one of the preceding claims is attached.
